(19) United States
(12) Patent Application Publication
(10) Pub. No.: US 2026/0203084 A1
(43) Pub. Date: Jul. 16, 2026

(54) SYSTEMS AND METHODS FOR WORKFLOW BASED FEATURE RECOMMENDATION

(71) Applicant: Dell Products L.P., Round Rock, TX (US)

(72) Inventors: Ryan N. COMER, Round Rock, TX (US); Robert C. HERNANDEZ, Morrisville, NC (US)

(73) Assignee: Dell Products L.P., Round Rock, TX (US)

(21) Appl. No.: 19/018,082

(22) Filed: Jan. 13, 2025

(51) Int. Cl. G06F 9/451

(52) U.S. Cl. CPC G06F 9/453

(57) ABSTRACT

An information handling system may include a processor and a workflow observer comprising a program of instructions embodied in non-transitory computer-readable media communicatively coupled to the processor. The workflow observer may be configured to, when read and executed by the processor, monitor interactions by a user with the information handling system, create periodic snapshots of the interactions, based on the periodic snapshots, generate a representation of a user workflow on the information handling system, calculate a semantic similarity between the user workflow and a feature, and if the semantic similarity exceeds a threshold, recommend the feature to a user of the information handling system.

### TECHNICAL FIELD

The present disclosure relates in general to information handling systems, and more particularly to reorganization of a user workspace in order to optimize user productivity.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Throughout the lifetime of an information handling system, a user may often engage in the same workflows to which they have grown accustomed, even when platform features may be available that could augment the user workflow. For example, a user may manually update the drivers for his or her information handing system when software may be available to perform such task. As another example, a user might never enable a spatial audio feature despite consistently consuming content that may leverage the feature.

### SUMMARY

In accordance with the teachings of the present disclosure, the disadvantages and problems associated with traditional approaches may be reduced or eliminated.

In accordance with embodiments of the present disclosure, an information handling system may include a processor and a workflow observer comprising a program of instructions embodied in non-transitory computer-readable media communicatively coupled to the processor. The workflow observer may be configured to, when read and executed by the processor, monitor interactions by a user with the information handling system, create periodic snapshots of the interactions, based on the periodic snapshots, generate a representation of a user workflow on the information handling system, calculate a semantic similarity between the user workflow and a feature, and if the semantic similarity exceeds a threshold, recommend the feature to a user of the information handling system.

In accordance with these and other embodiments of the present disclosure, a method may include monitoring interactions by a user with an information handling system, creating periodic snapshots of the interactions, based on the periodic snapshots, generating a representation of a user workflow on the information handling system, calculating a semantic similarity between the user workflow and a feature, and if the semantic similarity exceeds a threshold, recommending the feature to a user of the information handling system.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to monitor interactions by a user with an information handling system, create periodic snapshots of the interactions, based on the periodic snapshots, generate a representation of a user workflow on the information handling system, calculate a semantic similarity between the user workflow and a feature, and if the semantic similarity exceeds a threshold, recommend the feature to a user of the information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure; and

FIG. 2 illustrates a block diagram detailing an example method for workflow-based feature recommendation, in accordance with embodiments of the present disclosure.

### DETAILED DESCRIPTION

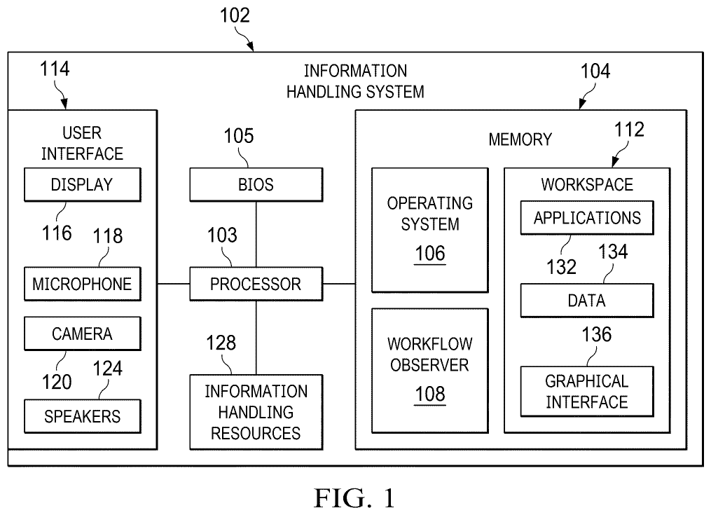

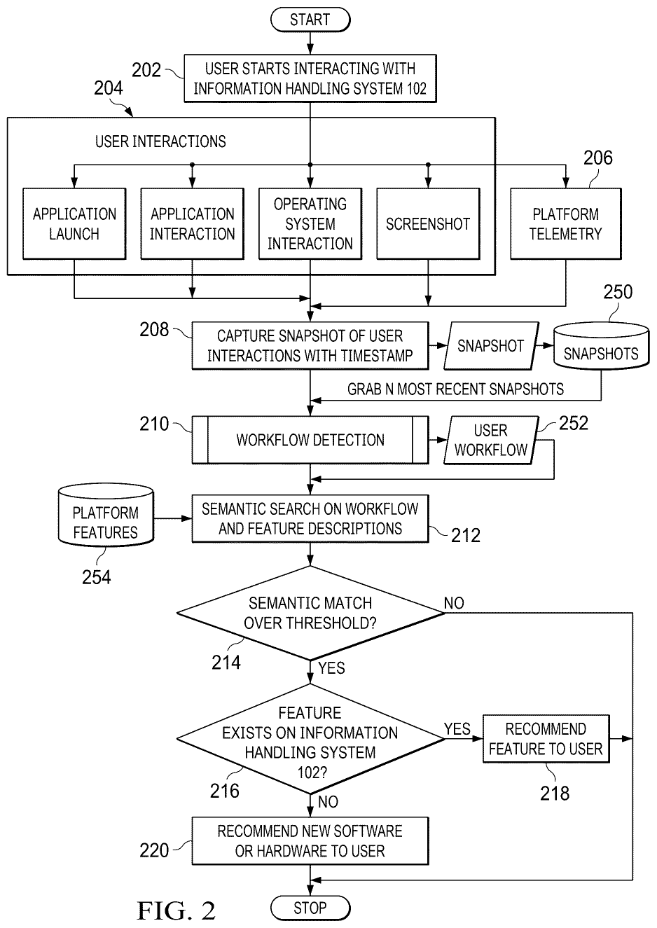

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a block diagram of selected components of an example information handling system 102, in accordance with embodiments of the present disclosure. In some embodiments, information handling system 102 may comprise or be an integral part of a server. In some embodiments, information handling system 102 may be a personal computer (e.g., a desktop computer or a portable computer). In other embodiments, information handling system 102 may comprise a mobile device (e.g., a smart phone, a tablet computing device, a handheld computing device, a personal digital assistant, or any other device that may be readily transported on a person of a user of such mobile device).

As depicted in FIG. 1, information handling system 102 may include a processor 103, a memory 104 communicatively coupled to processor 103, a user interface 114 communicatively coupled to processor 103, and one or more information handling resources 128 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

As shown in FIG. 1, memory 104 may have stored therein an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

As shown in FIG. 1, memory 104 may also have stored therein a workflow observer 108. Workflow observer 108 may comprise one or more programs of instructions, which may run on operating system 106 as an application program or utility, and may be configured to monitor a context of a user of information handling system 102 and based on such monitoring, dynamically compose the user's workspace based on the user's context and workspace usage characteristics, as described in greater detail below.

As further shown in FIG. 1, memory 104 may also have stored therein a workspace 112 for a user of information handling system 102. Workspace 112 may comprise a database, map, list, table, and/or other suitable data structure defining applications 132 installed and available to the user, data 134 available to the user, and a graphical interface 136 associated with the user (e.g., displayed to display 116). Graphical interface 136 may include active windows displayed to the user, icons associated with applications and/or files displayed to the user including any icons present in a dock of graphical interface 136, and/or any other graphical and/or alphanumeric information displayed to the user.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105.

User interface 114 may comprise any instrumentality or aggregation of instrumentalities by which a user may interact with information handling system 102. For example, user interface 114 may permit a user to input data and/or instructions into information handling system 102 (e.g., via a keypad, keyboard, touch screen, microphone, camera, and/or other data input device), and/or otherwise manipulate information handling system 102 and its associated components. User interface 114 may also permit information handling system 102 to communicate data to a user (e.g., via a display device, speaker, and/or other data output device). As shown in FIG. 1, user interface 114 may include one or more of a display 116, microphone 118, camera 120, and two or more speakers 124.

Display 116 may comprise any suitable system, device, or apparatus configured to display human-perceptible graphical data and/or alphanumeric data to a user. For example, in some embodiments, display 116 may comprise a liquid crystal display.

Microphone 118 may comprise any system, device, or apparatus configured to convert sound incident at microphone 118 to an electrical signal that may be processed by processor 103. In some embodiments, microphone 118 may include a capacitive microphone (e.g., an electrostatic microphone, a condenser microphone, an electret microphone, a microelectromechanical systems (MEMS) microphone, etc.) wherein such sound is converted to an electrical signal using a diaphragm or membrane having an electrical capacitance that varies based on sonic vibrations received at the diaphragm or membrane.

Camera 120 may comprise any system, device, or apparatus configured to record images (moving or still) into one or more electrical signals that may be processed by processor 103.

A speaker 124 may comprise any system, device, or apparatus configured to produce sound in response to electrical audio signal input.

In addition to processor 103, memory 104, BIOS 105, and user interface 114, information handling system 102 may include one or more other information handling resources 128. Such an information handling resource 128 may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

In operation, workflow observer 108 may monitor a user's workflow as the user interacts with information handling system 102, and based on such monitoring of interactions, determine if a feature may be used to augment the user's workflow. Such feature may already be available in workspace 112 or in other software or hardware available to purchase.

Features may be defined using a predefined schema. Such schema may define capabilities of each feature and describe how the features are typically used. As described in greater detail below, such schema descriptions may be used in a semantic search.

Workflow observer 108 may monitor a user's workflow as he or she interacts with information handling system 102. Such monitoring may include detecting launching of applications 132, interactions with data 134, interactions with operating system 106, screenshots of graphical interface 136, and/or any other suitable interactions. Such monitoring may also include the capture of telemetry data for information handling system 102. Workflow observer 108 may also capture periodic snapshots of the monitored interactions. Workflow observer 108 may also apply a vision language model to generate descriptions of the captured screenshots of graphical interface 136 to generate a description of the content displayed to display 116. Workflow observer 108 may also create embeddings based on the description of the screenshots, and the other monitored interactions, and store such embeddings (e.g., in a vector database).

Workflow observer 108 may further calculate a sematic similarity between the embeddings for the most recent snapshots and any predefined features (e.g., available on information handling system 102, available as a software or hardware upgrade to information handling system 102, or available on a new information handling system). Workflow 108 may determine if the similarity is over a threshold (which may be configurable in some embodiment), and if so, recommend the feature to the user, or recommend new software or hardware to the user needed to obtain the feature if information handling system 102 is not able to provide such feature.

FIG. 2 illustrates a block diagram detailing an example method 200 for workflow-based feature recommendation, in accordance with embodiments of the present disclosure. According to some embodiments, method 200 may begin at step 202. As noted above, teachings of the present disclosure may be implemented in a variety of configurations of information handling system 102.

At step 202, a user may begin interacting with information handling system 102. At step 204, workflow observer 108 may monitor a user's workflow as he or she interacts with information handling system 102. Such monitoring may include detecting launching of applications 132, interactions with data 134, interactions with operating system 106, screenshots of graphical interface 136, and/or any other suitable interactions. At step 206 (which may occur contemporaneously with step 204), workflow observer 108 may monitoring telemetry data for information handling system 102.

At step 208, workflow observer 108 may capture periodic snapshots of the monitored interactions and store such embeddings in a database 250 or other data structure of snapshots. At step 210, workflow observer 108 may perform workflow detection by analyzing a predetermined number of most recent snapshots. As part of the workflow detection process, workflow observer 108 may generate a representation of a user workflow 252 by applying a vision language model to generate descriptions of the captured screenshots of graphical interface 136 to generate a description of the content displayed to display 116. Workflow observer 108 may also generate the representation of user workflow 252 by creating embeddings based on the description of the screenshots, and the other monitored interactions stored in database 250.

At step 212, workflow observer 108 may calculate a sematic similarity between user workflow 252 and a database 254 of platform features. Such database 254 may exist locally on information handling system 102 and/or may be accessible from a cloud communicatively coupled to information handling system 102 via a network. The platform features may be defined using a predefined schema. Such schema may define capabilities of each feature and describe how the features are typically used. Such features may include those then-presently available on information handling system 102, those available as a software or hardware upgrade to information handling system 102, and/or those available on a new information handling system.

At step 214, workflow observer 108 may determine whether the semantic similarity for a particular feature exceeds a predefined threshold. In some embodiments, the predefined threshold may be configurable. If the semantic similarity exceeds the predefined threshold, method 200 may proceed to step 216. Otherwise method 200 may end (or in some embodiments, return to step 204).

At step 216, workflow observer 108 may determine whether the particular feature is available on information handling system 102. If the particular feature is available on information handling system 102, method 200 may proceed to step 218. Otherwise, method 200 may proceed to step 220.

At step 218, workflow observer 108 may recommend the particular feature to the user (e.g., via a visual alert to display 116). After completion of step 218, method 200 may end (or in some embodiments, return to step 204).

At step 220, workflow observer 108 may recommend new software and/or hardware (including a new information handling system) that the user may acquire to utilize the particular feature (e.g., via a visual alert to display 116). After completion of step 220, method 200 may end (or in some embodiments, return to step 204).

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

In some embodiments, workflow observer 108 may also persist user workflows in a database, which may provide a data source for a feedback mechanism to improve a workflow detection model.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor; and
a workflow observer comprising a program of instructions embodied in non-transitory computer-readable media communicatively coupled to the processor and configured to, when read and executed by the processor:
monitor interactions by a user with the information handling system;
create periodic snapshots of the interactions;
based on the periodic snapshots, generate a representation of a user workflow on the information handling system;
calculate a semantic similarity between the user workflow and a feature; and
if the semantic similarity exceeds a threshold, recommend the feature to a user of the information handling system.

2. The information handling system of claim 1, wherein the interactions include one or more of launching of applications of the information handling system, interactions with applications of the information handling system, interactions with an operating system of the information handling system, and screenshots for a display of the information handling system.

3. The information handling system of claim 1, wherein the workflow observer is further configured to:
monitor telemetry of the information handling system; and
create the periodic snapshots based on the interactions and the telemetry.

4. The information handling system of claim 1, wherein the feature is already present on the information handling system.

5. The information handling system of claim 1, wherein the feature is absent from the information handling system, and recommending the feature to the user of the information handling system comprises a recommendation to acquire software including the feature.

6. The information handling system of claim 1, wherein the feature is absent from the information handling system, and recommending the feature to the user of the information handling system comprises a recommendation to acquire hardware including the feature.

7. A method comprising:
monitoring interactions by a user with an information handling system;
creating periodic snapshots of the interactions;
based on the periodic snapshots, generating a representation of a user workflow on the information handling system;
calculating a semantic similarity between the user workflow and a feature; and
if the semantic similarity exceeds a threshold, recommending the feature to a user of the information handling system.

8. The method of claim 7, wherein the interactions include one or more of launching of applications of the information handling system, interactions with applications of the information handling system, interactions with an operating system of the information handling system, and screenshots for a display of the information handling system.

9. The method of claim 7, further comprising:
monitoring telemetry of the information handling system; and
creating the periodic snapshots based on the interactions and the telemetry.

10. The method of claim 7, wherein the feature is already present on the information handling system.

11. The method of claim 7, wherein the feature is absent from the information handling system, and recommending the feature to the user of the information handling system comprises a recommendation to acquire software including the feature.

12. The method of claim 7, wherein the feature is absent from the information handling system, and recommending the feature to the user of the information handling system comprises a recommendation to acquire hardware including the feature.

13. An article of manufacture comprising:
a non-transitory computer-readable medium; and
computer-executable instructions carried on the computer-readable medium, the instructions readable by a processor, the instructions, when read and executed, for causing the processor to:
monitor interactions by a user with an information handling system;
create periodic snapshots of the interactions;
based on the periodic snapshots, generate a representation of a user workflow on the information handling system;
calculate a semantic similarity between the user workflow and a feature; and
if the semantic similarity exceeds a threshold, recommend the feature to a user of the information handling system.

14. The article of claim 13, wherein the interactions include one or more of launching of applications of the information handling system, interactions with applications of the information handling system, interactions with an operating system of the information handling system, and screenshots for a display of the information handling system.

15. The article of claim 13, the instructions for further causing the processor to:
monitor telemetry of the information handling system; and
create the periodic snapshots based on the interactions and the telemetry.

16. The article of claim 13, wherein the feature is already present on the information handling system.

17. The article of claim 13, wherein the feature is absent from the information handling system, and recommending the feature to the user of the information handling system comprises a recommendation to acquire software including the feature.

18. The article of claim 13, wherein the feature is absent from the information handling system, and recommending the feature to the user of the information handling system comprises a recommendation to acquire hardware including the feature.
